(19) United States
(12) Patent Application Publication
(10) Pub. No.: US 2008/0186326 A1
(43) Pub. Date: Aug. 7, 2008

(54) Image Interpolation Method

(76) Inventor: HYUNG WOOK LEE, Siheung-si (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 12/026,664

(22) Filed: Feb. 6, 2008

(30) Foreign Application Priority Data
Feb. 6, 2007 (KR) 10-2007-0012314

(51) Int. Cl. G09G 5/02

(52) U.S. Cl. 345/600

(57) ABSTRACT

An image interpolation method is provided, including the steps of detecting a color value of each pixel provided in a pixel array; calculating R/G/B (red/green/blue) color values of a central pixel aligned at a center of a unit block provided in the pixel array; calculating R/G/B standard deviations based on a difference between the R/G/B color values of the central pixel and color values of other pixels provided in the pixel block; creating corrected blocks having color values obtained by taking the R/G/B standard deviations into consideration and by comparing the R/G/B color values of the central pixel and the color values of other pixels provided in the pixel block; and obtaining an interpolated color value of the central pixel by using the color values of pixels included in the corrected block.

### CROSS-REFERENCE TO RELATED APPLICATION

The present application claims the benefit under 35 U.S.C. §119 of Korean Patent Application No. 10-2007-0012314, filed Feb. 6, 2007, which is hereby incorporated by reference in its entirety.

### BACKGROUND

An image sensor is a device used in a camera module of, for example, a mobile phone or a PC (personal computer).

Recently, a CMOS (complementary metal-oxide semiconductor) image sensor has been extensively used. The CMOS image sensor has a simple driving scheme as compared with that of a CCD (charge coupled device) image sensor. In addition, since signal processing circuits can be integrated in one chip, the CMOS image sensor can realize a SOC (system on chip), so the size of the module can be reduced. Further, the CMOS image sensor can compatibly use the conventional CMOS technology, so the manufacturing cost for the CMOS image sensor can be reduced.

The image sensor performs interpolation to obtain color values of R (red), G (green) and B (blue) with respect to all pixels. That is, the image sensor creates three color values relative to one pixel through interpolation.

According to a typical interpolation scheme, the color value is obtained by using the mean value of the colors.

FIGS. 1 to 4 are views showing the conventional interpolation scheme that obtains the color values by using the mean value of colors.

FIG. 1 shows a block having 3×3 pixels provided in a pixel array. In FIG. 1, B11 refers to a blue color value of a pixel designated by a numeral 11, and G10 refers to a green color value of a pixel designated by a numeral 10. The numeral of the pixel is to distinguish the pixels from each other for the purpose of convenience.

In addition, the 11^{th} block refers to the block shown in FIG. 1, in which a numeral 11 of the 11^{th} block mates with a numeral of a central pixel (B11) to facilitate the explanation.

In the case of the pixel {11}, which is the central pixel in the 11^{th} block, a blue color value is detected from the pixel {11}, and green and red color values of the pixel {11}, which are not detected from the pixel {11}, can be obtained by performing the interpolation according to following equation 1 by using color values of adjacent pixels.

The red color value of the pixel {11} is designated by R11, and the green color value of the pixel {11} is designated by G11.

Equation 1

G11=(G10+G01+G21+G12)/4

R11=(R00+R20+R02+R22)/4

B11=B11 (1)

In the same manner, the color values of pixels provided in the pixel array shown in FIG. 2 can be obtained through the interpolation equations as shown in Table 1.

TABLE 1

| Block | Interpolation equation |
|---|---|
| 11^{th} block (11) | G11 = (G10 + G01 + G21 + G12)/4 |
| | R11 = (R00 + R20 + R12 + R22)/4 |
| | B11 = B11 |
| 21^{st} block (21) | G21 = G21 |
| | R21 = (R20 + R22)/2 |
| | B11 = (B11 + B31)/2 |
| 12^{th} block (12) | G12 = G12 |
| | R12 = (R02 + R22)/2 |
| | B12 = (B11 + B13)/2 |
| 22^{nd} block (22) | G22 = (G21 + G12 + G32 + G23)/4 |
| | R22 = R22 |
| | B22 = (B11 + B31 + B13 + B33)/4 |

However, when the color values of the pixels are obtained through the conventional interpolation scheme, if there is great difference in color values between adjacent pixels, the mean value error may occur.

For example, FIG. 3 shows color values of pixels of a pixel array where great differences in color values exist between certain adjacent pixels. Here, the mean value of the R, G and B of the pixels provided in the pixel array has an error when the remaining two color values are calculated through interpolation. That is, as shown in FIG. 4, the new color values have an error in their mean value, so the color values may not serve as representative color values for a region where great image variation occurs.

### BRIEF SUMMARY

Embodiments of the present invention provide image interpolation methods.

In an embodiment, an image interpolation method capable of reducing an error in the mean value of colors is provided.

Further, an embodiment provides an image interpolation method capable of reducing an interpolation distance.

According to an embodiment of the present invention, there is provided an image interpolation method comprising: detecting a color value of each pixel provided in a pixel array; calculating R/G/B (red/green/blue) color values of a central pixel aligned at a center of a unit block provided in the pixel array; calculating R/G/B standard deviations based on a difference between the R/G/B color values of the central pixel and color values of other pixels provided in the pixel block; creating corrected blocks having corrected color values obtained by taking the R/G/B standard deviations into consideration, where the corrected blocks are created by comparing the R/G/B color values of the central pixel and the color values of other pixels provided in the pixel block; and obtaining an interpolated color value of the central pixel by using the color values of pixels included in the corrected block.

### BRIEF DESCRIPTION OF THE DRAWINGS

FIG. 1 is a view showing a pixel array having 3×3 pixels.

FIG. 2 is a view showing a pixel array having a plurality of blocks.

FIG. 3 is a view showing a pixel array having pixels designated with color values thereof.

FIG. 4 is a table showing a mean value of R, G and B of pixels provided in each block.

FIG. 5 is a view showing an RGB interpolation unit that performs interpolation by reading a block from a pixel array according to an embodiment of the present invention.

FIG. 6 is a view showing the 21^{st} block according to an embodiment of the present invention.

FIG. 7 is a table showing R/G/B mean values, the standard deviation and values of corrected blocks of the 21^{st} block according to an embodiment of the present invention.

FIG. 8 is a view showing a corrected block that is newly created from the 21^{st} block according to an embodiment of the present invention.

FIG. 9 is a flowchart showing the interpolation procedure, which is performed by taking the standard deviation into consideration, according to an embodiment of the present invention.

FIG. 10 is a view showing corrected blocks that are newly created by correcting the 11^{th}, 21^{st}, 12^{th} and 22^{nd} blocks, respectively, according to an embodiment of the present invention.

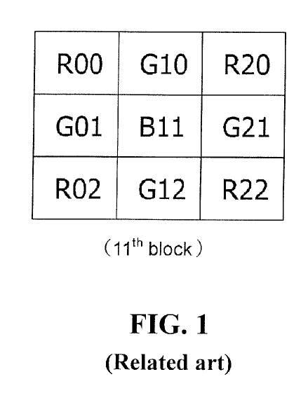

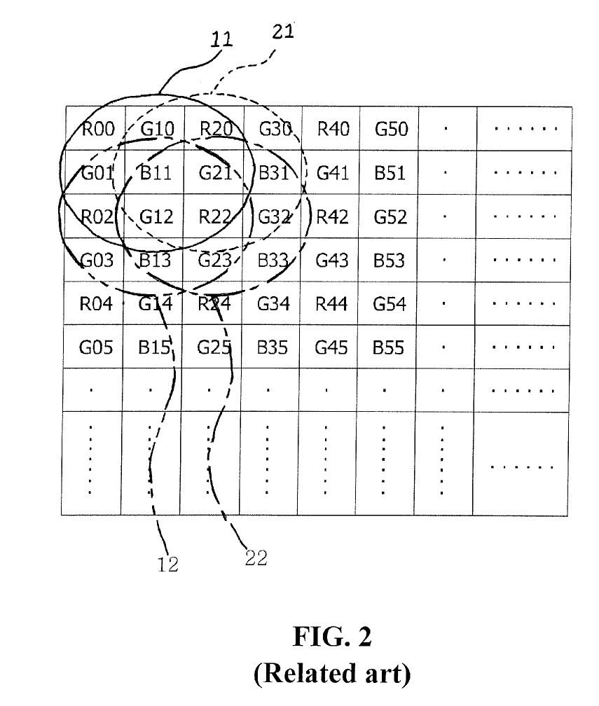

### DETAILED DESCRIPTION

Hereinafter, embodiments will be described with reference to the accompanying drawings. The same elements may have the same reference numerals even if they are shown in different drawings.

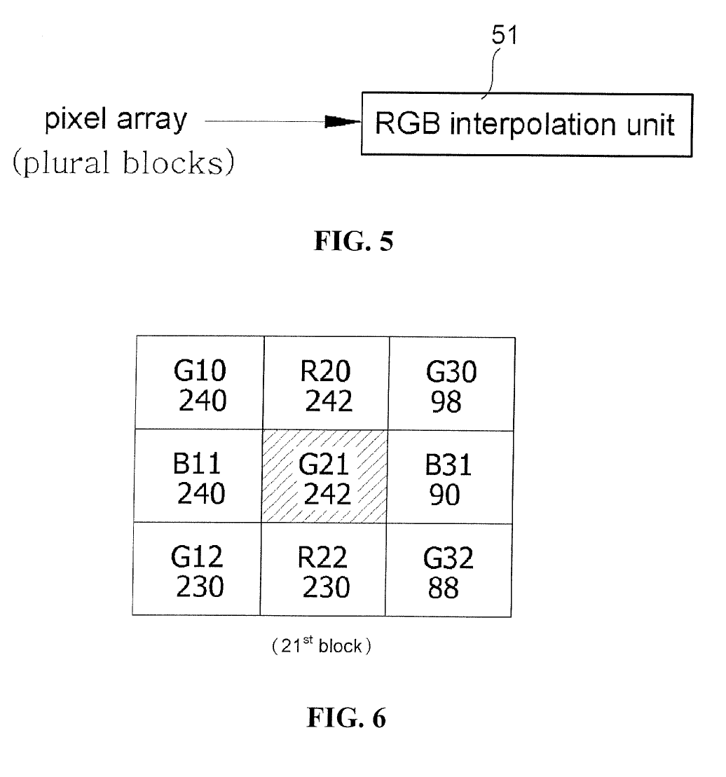

FIG. 5 is a view showing an RGB interpolation unit 51 provided in an image sensor according to an embodiment of the present invention.

The RGB (red-green-blue) interpolation unit 51 can obtain the R/G/B (red/green/blue) mean value of a central pixel in each unit block of a pixel array having a predetermined pixel structure (for instance, 3×3 pixels). If the R/G/B mean value is equal to or less than a color value of a corresponding pixel provided in the unit block, the RGB interpolation unit 51 can correct the color value of the corresponding pixel by adding the R/G/B standard deviation to the R/G/B mean value. In addition, if the R/G/B mean value is greater than the color value of the corresponding pixel provided in the unit block, the RGB interpolation unit 51 can correct the color value of the corresponding pixel by subtracting the R/G/B standard deviation from the R/G/B mean value, thereby creating new unit blocks that are corrected by taking the standard deviation into consideration. Subsequently, the interpolation can be performed relative to the new unit blocks to obtain the mean value of colors.

Prior to explaining the structure of the pixel array, the interpolation relative to a unit block, which is a part of the pixel array, will be described to facilitate the explanation.

Referring to the 21^{st} block example shown in FIG. 6, the color values are significantly varied in the boundary area between pixels {20}, {21} and {22} and pixels {30}, {31} and {32}. Thus, if the interpolation is simply performed by using the mean value, the mean value error may occur. For this reason, according to an embodiment, new unit blocks are created by correcting the unit blocks based on the standard deviation and the interpolation is performed relative to the new unit blocks.

To this end, according to an embodiment, when the interpolation is performed relative to the central pixel {21} by reading the 21^{st} block having 3×3 pixels from a pixel array, a new block (hereinafter, referred to as a corrected block) is created by taking the standard deviation into consideration and the interpolation is performed relative to the corrected block.

Meanwhile, although this embodiment is described in that the interpolation is performed with respect to the unit block having 3×3 pixels, it is also possible to perform the interpolation with respect to the unit pixel having, for example, 5×5 pixels. That is, according to certain embodiments, the interpolation can be performed with respect to a unit block having (odd number)×(odd number) pixels.

Hereinafter, the correction for pixels of the 21^{st} block shown in FIG. 6 will be described.

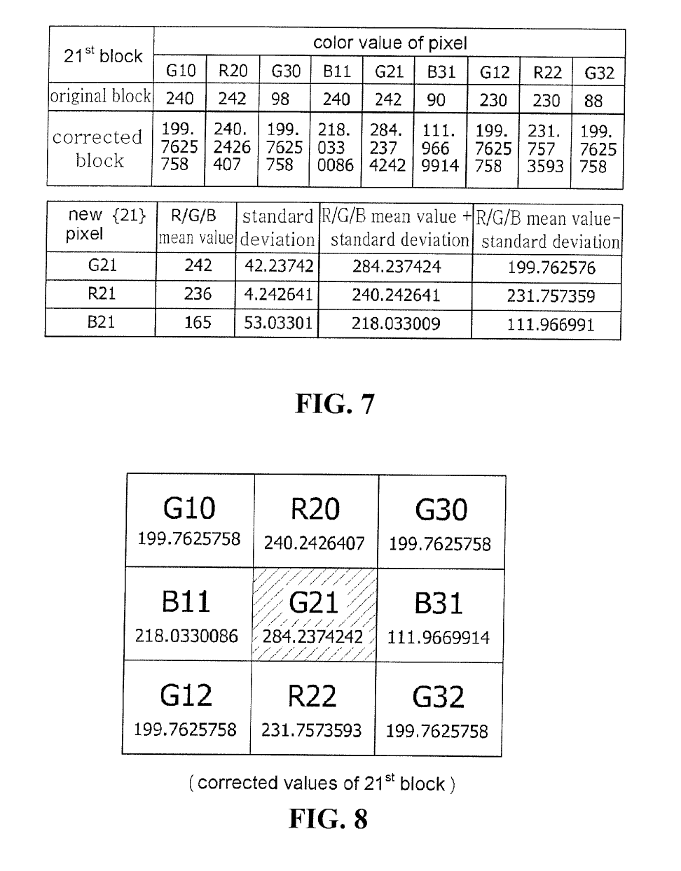

FIG. 7 is a table that shows the R/G/B mean value, and the standard deviation of the central pixel {21} of the 21^{st} block shown in FIG. 6.

Referring to FIGS. 6 and 7, a G color of a pixel {10} (hereinafter, referred to as G10) provided in the 21^{st} block has a color value of 240. In addition, R20, G30, B11, G21, B31, G12, R22, and G32 have the color values of 242, 98, 240, 242, 90, 230, 230 and 88, respectively.

The R/G/B mean values of the pixels provided in the 21^{st} block can be obtained from the above color values. For instance, the G21 has the mean value of 242, which is identical to the color value thereof, and the R21 has the mean value of (R20+R22)/2=(242+230)/2=236. In addition, the B21 has the mean value of (B11+B31)/2=(240+90)/2=165.

Meanwhile, the standard deviation of each color of the pixel can be obtained through a well-known equation, which is generally used for calculating the standard deviation. That is, the standard deviation can be obtained from equation 2. According to an embodiment, the standard deviation of each color of the pixel can be obtained from equation 2.

$$\begin{matrix}Equation 2 & \\ STANDARD DEVIATION = \frac{\sqrt{( \begin{matrix}{( mean value - firstvalue )}^{2} + … + \\ {( mean value - {N}^{th} value )}^{2}\end{matrix} )}}{N} & ( 2 )\end{matrix}$$

In addition, the standard deviations of the G21, R21 and B21 can be obtained as follows by using equation 2.

$$\begin{matrix}Equation 3 & \\ \begin{matrix}\begin{matrix}STANDARD \\ DEVIATION \\ of {G}_{21}\end{matrix} = \frac{\sqrt{( \begin{matrix}{( {G}_{21} meanvalue - {G}_{10} )}^{2} + \\ {( {G}_{21} meanvalue - {G}_{30} )}^{2} + \\ {( {G}_{21} meanvalue - {G}_{21} )}^{2} + \\ {( {G}_{21} meanvalue - {G}_{12} )}^{2} + \\ {( {G}_{21} meanvalue - {G}_{32} )}^{2}\end{matrix} )}}{5} \\ = \frac{\sqrt{( \begin{matrix}{( 242 - 240 )}^{2} + {( 242 - 98 )}^{2} + \\ {( 242 - 242 )}^{2} + \\ {( 242 - 230 )}^{2} + {( 242 - 88 )}^{2}\end{matrix} )}}{5} \\ = 42.23742\end{matrix} & ( 3 ) \\ Equation 4 & \\ \begin{matrix}\begin{matrix}STANDARD \\ DEVIATION of {R}_{21}\end{matrix} = \frac{\sqrt{\begin{matrix}( {( {R}_{21} meanvalue - {R}_{20} )}^{2} + \\ {( {R}_{21} meanvalue - {R}_{22} )}^{2} )\end{matrix}}}{2} \\ = \frac{\sqrt{( {( 236 - 242 )}^{2} + {( 236 - 230 )}^{2} )}}{2} \\ = 4.242641\end{matrix} & ( 4 ) \\ Equation 5 & \\ \begin{matrix}\begin{matrix}STANDARD \\ DEVIATION of {B}_{21}\end{matrix} = \frac{\sqrt{( \begin{matrix}{( {B}_{21} mean value - {B}_{11} )}^{2} + \\ {( {B}_{21} mean value - {B}_{31} )}^{2}\end{matrix} )}}{2} \\ = \frac{\sqrt{( {( 165 - 240 )}^{2} + {( 165 - 90 )}^{2} )}}{2} \\ = 53.03301\end{matrix} & \end{matrix}$$

(5)

The values obtained by adding or subtracting the standard deviations of the G21, R21 and B21 to or from the mean values thereof are shown in FIG. 7 as “R/G/B mean value+standard deviation” and “R/G/B mean value−standard deviation”.

After obtaining the standard deviations of the G21, R21 and B21, the correction is performed by adding or subtracting the standard deviations to or from the R/G/B mean value, thereby creating new unit blocks, that is, corrected blocks.

For example, if the R/G/B mean value of the pixel {21} is equal to or less than the color value of the corresponding pixel provided in the unit block, the color value of the corresponding pixel is newly established by adding the R/G/B standard deviation to the R/G/B mean value of the pixel {21}. In addition, if the R/G/B mean value of the pixel {21} is greater than the color value of the corresponding pixel provided in the unit block, the color value of the corresponding pixel is newly established by subtracting the R/G/B standard deviation from the R/G/B mean value of the pixel {21}, thereby creating corrected blocks.

That is, as shown in FIG. 7, the G21 of the pixel {21} has the mean value of 242, which is greater than the color value (240) of the G10 of the pixel {10}. In this case, the color value of the G10 is corrected to 199.762576(=242−42.23742) by taking the standard deviation into consideration.

In addition, the R21 of the pixel {21} has the mean value of 236, which is smaller than the color value (242) of the R20 of the pixel {20}. In this case, the color value of the R20 is corrected to 240.242641(=236+4.242641) by taking the standard deviation into consideration.

In this manner, the correction is performed according to the R/G/B mean value of the pixel and the color value of the corresponding pixel by taking the standard deviation into consideration, so that the color value of the G10 is corrected from 240 to 199.7626, the color value of the R20 is corrected from 242 to 240.242641, the color value of the G30 is corrected from 98 to 199.7626, the color value of the B11 is corrected from 240 to 218.033, the color value of the G21 is corrected from 242 to 284.2374, the color value of the B31 is corrected from 90 to 111.967, the color value of the G12 is corrected from 230 to 199.7626, the color value of the R22 is corrected from 230 to 231.7574, and the color value of the G32 is corrected from 88 to 199.762, thereby forming new corrected blocks. FIG. 8 shows the pixel values of the new unit block that is obtained by correcting the unit block shown in FIG. 6 based on the standard deviation.

Then, the values of the pixel {21} can be obtained by performing the interpolation relative to the corrected block. Table 2 provides the color values of pixels obtained through interpolation relative to the corrected block according to an embodiment of the present invention.

TABLE 2

| | | pixel of | Original | | Interpolated value of G21 (mean |
|---|---|---|---|---|---|
| block | color | block | color value | Corrected value | value after correction) |
| 21^{st} | G | G10 | 240 | 199.7625758 | 216.6575458 |
| block | | | | (G21 mean value − G21 | |
| | | | | standard deviation) | |
| | | G30 | 98 | 199.7625758 | |
| | | | | (G21 mean value − G21 | |
| | | | | standard deviation) | |
| | | G21 | 242 | 284.2374242 | |
| | | | | (G21 mean value + G21 | |
| | | | | standard deviation) | |
| | | G12 | 230 | 199.7625758 | |
| | | | | (G21 mean value − G21 | |
| | | | | standard deviation) | |
| | | G32 | 88 | 199.7625758 | |
| | | | | (G21 mean value − G21 | |
| | | | | standard deviation) | |
| | R | R20 | 242 | 240.2426407 | 236 |
| | | | | (R21 mean value + R21 | |
| | | | | standard deviation) | |
| | | R22 | 230 | 231.7573593 | |
| | | | | (R21 mean value − R21 | |
| | | | | standard deviation) | |
| | B | B11 | 240 | 218.0330086 | 165 |
| | | | | (B21 mean value + B21 | |
| | | | | standard deviation) | |
| | | B31 | 90 | 111.9669914 | |
| | | | | (B21 mean value − B21 | |
| | | | | standard deviation) | |

Referring to Table 2, the interpolated value of each color, which is the mean value of the color values that are corrected by taking the standard deviation into consideration, is represented as G=216.6575458, R=236 and B=165.

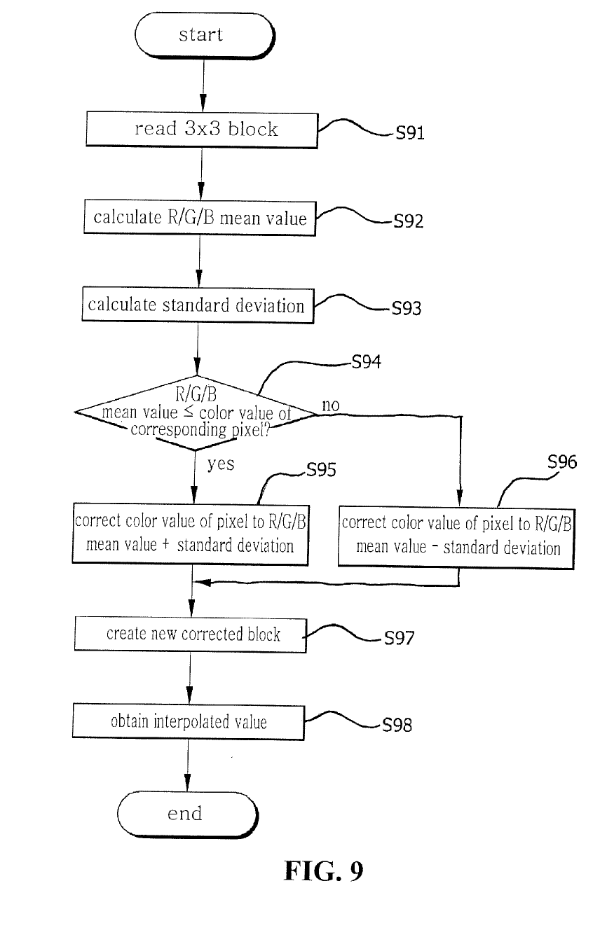

FIG. 9 is a flowchart showing an interpolation algorithm that is performed based on the standard deviation according to an embodiment of the present invention.

According to an embodiment of the present invention, the RGB interpolation unit reads the color value of a unit block having, for example, 3×3 pixels including a pixel subject to the interpolation (S91) and calculates the R/G/B mean value of the pixels provided in the unit block (S92). As an example, if the unit block is the 21^{st} block having the color values as shown in FIG. 6 (that is, G10=240, R20=242, G30=98, B11=240, G21=242, B31=90, G12=230, R22=230, and G32=88), the R/G/B mean values of the pixels provided in the 21^{st} block are represented as G21=242, which is identical to the color value thereof, and R21=(R20+R22)/2=(242+232)/2=236. In addition, B21 has the mean value of (B11+B31)/2=(240+90)/2=165.

After obtaining the R/G/B mean value of the pixels provided in the unit block, the standard deviations of the colors in the unit block are calculated (S93). Returning to the example of the unit block being the 21^{st} block shown in FIG. 6, the standard deviations of the G21, R21 and B21 can be obtained through the equations 3 to 5 based on equation 2 as described above.

After the R/G/B mean values and the standard deviations of the pixels of the unit block have been obtained, the R/G/B mean value of the pixel is compared with the color value of the corresponding pixel provided in the pixel array (S94).

If the R/G/B mean value of the pixel is equal to or less than the color value of the corresponding pixel, the color value of the corresponding pixel is corrected by adding the standard deviation to the R/G/B mean value (S95). In contrast, if the R/G/B mean value of the pixel is greater than the color value of the corresponding pixel, the color value of the corresponding pixel is corrected by subtracting the standard deviation from the R/G/B mean value (S96), thereby forming corrected blocks (S97).

Table 2 above shows the color values that are corrected by taking the standard deviation into consideration for the 21^{st} block example. Referring to Table 2, the G10 is corrected from 240 to 199.7626, the R20 is corrected from 242 to 240.242641, the G30 is corrected from 98 to 199.7626, the B11 is corrected from 240 to 218.033, the G21 is corrected from 242 to 284.2374, the B31 is corrected from 90 to 111.967, the G12 is corrected from 230 to 199.7626, the R22 is corrected from 230 to 231.7574, and the G32 is corrected from 88 to 199.7626. As a result, a new unit block as shown in FIG. 8 can be obtained through the correction based on the standard deviation.

Subsequently, the R/G/B mean value is calculated with respect to the pixels provided in the corrected block, thereby obtaining the interpolated color value (S98).

For instance, as shown in Table 2, the G values of the 21^{st} block, which are corrected by taking the standard deviation into consideration, are represented as 199.7625758 (G10), 199.7625758 (G30), 284.2374242 (G21), and 199.7625758 (G12), 199.7625758 (G32), the interpolated value of the G21 is represented as (199.7625758+199.7625758+284.2374242+199.7625758+199.7625758)÷5=216.6575458.

In the same manner, the R values of the 21^{st} block, which are corrected by taking the standard deviation into consideration, are represented as 240.2426407 (R20) and 231.7573593 (R22), the interpolated value of the R21 is represented as (240.2426407+231.7573593)÷2=236. In addition the B values of the 21^{st} block, which are corrected by taking the standard deviation into consideration, are represented as 218.0330086 (B11) and 111.9669914 (B31), the interpolated value of the B21 is represented as (218.0330086+111.9669914)÷2=165.

Meanwhile, it should be noted that the flowchart shown in FIG. 9 exhibits the interpolation procedure relative to one specific block of the pixel array in order to facilitate explanation.

However, the interpolation can be performed relative to all blocks of the pixel array. When the interpolation is performed with respect to all blocks of the pixel array, the standard deviations of colors in each block are calculated according to equations 2 to 5 in order to create corrected blocks, and then the procedure shown in FIG. 9 is repeated to perform the interpolation with respect to the corrected blocks

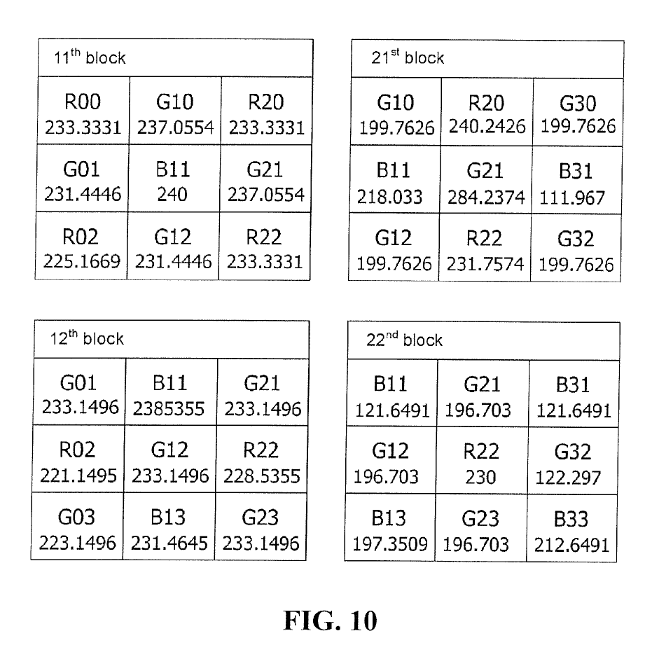

FIG. 10 is a view showing the corrected blocks which are newly created by correcting the 11^{th}, 21^{st}, 12^{th}, and 22^{nd} blocks, respectively. Although FIG. 10 shows only four blocks, it is clear that the interpolation with respect to the remaining blocks can be performed after creating new blocks by correcting the remaining blocks.

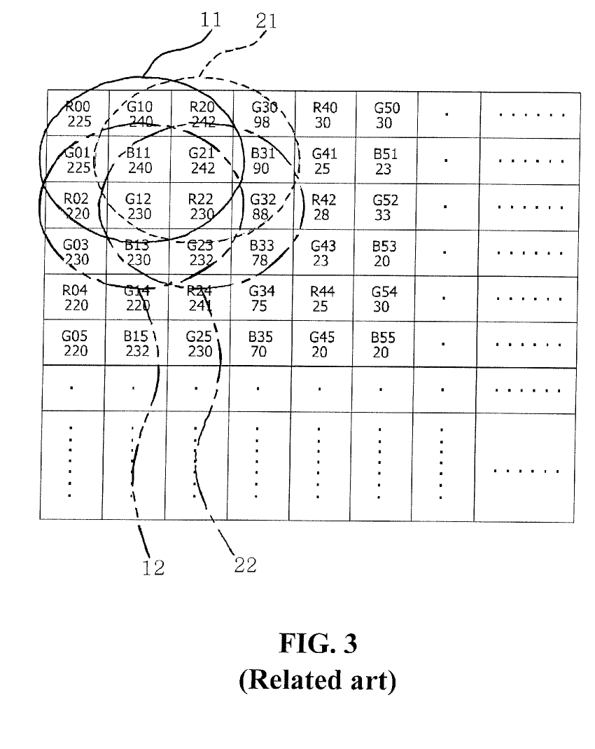

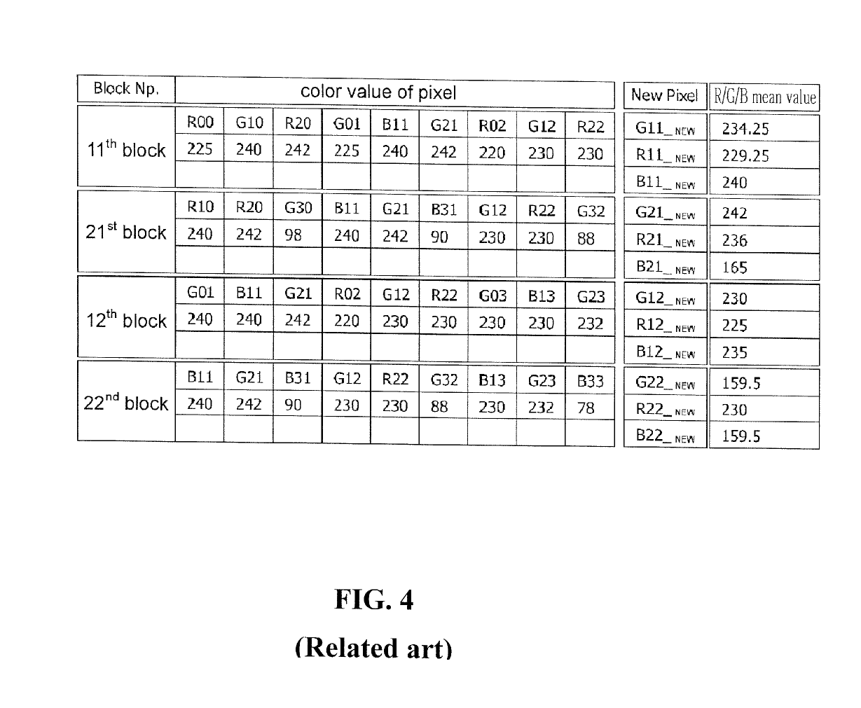

In addition, Table 3 exhibits the mean value, the standard deviation and the interpolated color value obtained from the 11^{th}, 21^{st}, 12^{th}, and 22^{nd} blocks provided in the pixel array as shown in FIG. 3. Although Table 3 shows data obtained from the four blocks, the interpolation can also be performed with respect to the remaining blocks.

TABLE 3

| | | Pixel of | Original | | Interpolated color value (mean |
|---|---|---|---|---|---|
| block | color | block | color value | Corrected value | value after correction) |
| 11^{th} | G | G10 | 240 | 237.055352 | 234.25 |
| block | | | | (G11 mean value + G11 | |
| | | | | standard deviation) | |
| | | G01 | 225 | 231.444648 | |
| | | | | (G11 mean value − G11 | |
| | | | | standard deviation) | |
| | | G21 | 242 | 237.055352 | |
| | | | | (G11 mean value + G11 | |
| | | | | standard deviation) | |
| | | G12 | 230 | 237.055352 | |
| | | | | (G11 mean value − G11 | |
| | | | | standard deviation) | |
| | R | R00 | 225 | 233.3331207 | 231.2915604 |
| | | | | (R11 mean value + R11 | |
| | | | | standard deviation) | |
| | | R20 | 242 | 233.3331207 | |
| | | | | (R11 mean value + R11 | |
| | | | | standard deviation) | |
| | | R02 | 220 | 225.1668793 | |
| | | | | (R11 mean value − R11 | |
| | | | | standard deviation) | |
| | | R22 | 230 | 233.3331207 | |
| | | | | (R11 mean value + R11 | |
| | | | | standard deviation) | |
| | B | B11 | 240 | 240 | 240 |
| 21^{st} | G | G10 | 240 | 199.7625758 | 216.6575458 |
| block | | | | (G21 mean value − G21 | |
| | | | | standard deviation) | |
| | | G30 | 98 | 199.7625758 | |
| | | | | (G21 mean value − G21 | |
| | | | | standard deviation) | |
| | | G21 | 242 | 284.2374242 | |
| | | | | (G21 mean value + G21 | |
| | | | | standard deviation) | |
| | | G12 | 230 | 199.7625758 | |
| | | | | (G21 mean value − G21 | |
| | | | | standard deviation) | |
| | | G32 | 88 | 199.7625758 | |
| | | | | (G21 mean value − G21 | |
| | | | | standard deviation) | |
| | R | R20 | 242 | 240.2426407 | 236 |
| | | | | (R21 mean value + R21 | |
| | | | | standard deviation) | |
| | | R22 | 230 | 231.7573593 | |
| | | | | (R21 mean value − R21 | |
| | | | | standard deviation) | |
| | B | B11 | 240 | 218.0330086 | 165 |
| | | | | (B21 mean value + B21 | |
| | | | | standard deviation) | |
| | | B31 | 90 | 111.9669914 | |
| | | | | (B21 mean value − B21 | |
| | | | | standard deviation) | |
| 12^{th} | G | G01 | 225 | 233.1496031 | 233.1496031 |
| block | | | | (G12 mean value + G12 | |
| | | | | standard deviation) | |
| | | G21 | 242 | 233.1496031 | |
| | | | | (G12 mean value + G12 | |
| | | | | standard deviation) | |
| | | G12 | 230 | 233.1496031 | |
| | | | | (G12 mean value + G12 | |
| | | | | standard deviation) | |
| | | G03 | 230 | 233.1496031 | |
| | | | | (G12 mean value + G12 | |
| | | | | standard deviation) | |
| | | G23 | 232 | 233.1496031 | |
| | | | | (G12 mean value + G12 | |
| | | | | standard deviation) | |
| | R | R02 | 220 | 221.4644661 | 225 |
| | | | | (R12 mean value − R12 | |
| | | | | standard deviation) | |
| | | R22 | 230 | 228.5355339 | |
| | | | | (R12 mean value + R12 | |
| | | | | standard deviation) | |
| | B | B11 | 240 | 238.5355339 | 235 |
| | | | | (B12 mean value + B12 | |
| | | | | standard deviation) | |
| | | B13 | 230 | 231.4644661 | |
| | | | | (B12 mean value − B12 | |
| | | | | standard deviation) | |
| 22^{nd} | G | G21 | 242 | 196.7029905 | 178.1014952 |
| block | | | | (G22 mean value + G22 | |
| | | | | standard deviation) | |
| | | G12 | 230 | 196.7029905 | |
| | | | | (G22 mean value + G22 | |
| | | | | standard deviation) | |
| | | G32 | 88 | 122.2970097 | |
| | | | | (G22 mean value − G22 | |
| | | | | standard deviation) | |
| | | G23 | 232 | 196.7029905 | |
| | | | | (G22 mean value + G22 | |
| | | | | standard deviation) | |
| | R | R22 | 230 | 230 | 230 |
| | B | B11 | 240 | 121.6491414 | 140.5745707 |
| | | | | (B22 mean value − B22 | |
| | | | | standard deviation) | |
| | | B31 | 90 | 121.6491414 | |
| | | | | (B22 mean value − B22 | |
| | | | | standard deviation) | |
| | | B13 | 230 | 197.3508586 | |
| | | | | (B22 mean value + B22 | |
| | | | | standard deviation) | |
| | | B33 | 78 | 121.6491414 | |
| | | | | (B22 mean value − B22 | |
| | | | | standard deviation) | |

Meanwhile, the interpolation according to an embodiment, which is performed by creating corrected blocks based on the R/G/B mean value and the standard deviation, represents high accuracy as compared with the conventional interpolation that is performed based on the mean values of the pixels. This will become clear from Table 4 showing the conventional interpolation distance and Table 5 showing the interpolation distance according to an embodiment of the present invention.

TABLE 4

| | Dis_Mean | | Mean_Dis_{—Mean} | |
|---|---|---|---|---|
| 11^{th} block | G(G10 − G11_{Mean}) | 5.75 | 6.75 | 4.5 |
| | G(G01 − G11_{Mean}) | 9.25 | | |
| | G(G21 − G11_{Mean}) | 7.75 | | |
| | G(G12 − G11_{Mean}) | 4.25 | | |
| | R(R00 − R11_{Mean}) | 4.25 | 6.75 | |
| | R(R20 − R11_{Mean}) | 12.75 | | |
| | R(R02 − R11_{Mean}) | 9.25 | | |
| | R(R22 − R11_{Mean}) | 0.75 | | |
| | B(B11 − B11_{Mean}) | 0 | 0 | |
| 21^{st} block | G(G10 − G21_{Mean}) | 2 | 62.4 | 36.96667 |
| | G(G30 − G21_{Mean}) | 144 | | |
| | G(G21 − G21_{Mean}) | 0 | | |
| | G(G12 − G21_{Mean}) | 12 | | |
| | G(G32 − G21_{Mean}) | 154 | | |
| | R(R20 − R21_{Mean}) | 6 | 6 | |
| | R(R22 − R21_{Mean}) | 6 | | |
| | B(B11 − B21_{Mean}) | 10 | 42.5 | |
| | B(B31 − B21_{Mean}) | 75 | | |
| 12^{th} block | G(G01 − G12_{Mean}) | 10 | 4.8 | 4.933333 |
| | G(G21 − G12_{Mean}) | 12 | | |
| | G(G12 − G12_{Mean}) | 0 | | |
| | G(G03 − G12_{Mean}) | 0 | | |
| | G(G23 − G12_{Mean}) | 2 | | |
| | R(R02 − R12_{Mean}) | 5 | 5 | |
| | R(R22 − R12_{Mean}) | 5 | | |
| | B(B11 − B12_{Mean}) | 5 | 5 | |
| | B(B13 − B12_{Mean}) | 5 | | |
| 22^{nd} block | G(G21 − G22_{Mean}) | 82.5 | 74.25 | 43.125 |
| | G(G12 − G22_{Mean}) | 70.5 | | |
| | G(G32 − G22_{Mean}) | 71.5 | | |
| | G(G23 − G22_{Mean}) | 72.5 | | |
| | R(R22 − R22_{Mean}) | 0 | 0 | |
| | B(B11 − B22_{Mean}) | 80.5 | 55.125 | |
| | B(B31 − B22_{Mean}) | 69.5 | | |
| | B(B13 − B22_{Mean}) | 70.5 | | |

TABLE 5

| | Dis_Mean | | Mean_Dis_{—std} | |
|---|---|---|---|---|
| 11^{th} | G(G10 − G11_{Mean}) | 2.944647972 | 3.944647972 | 3.439883 |
| block | G(G01 − G11_{Mean}) | 6.444647972 | | |
| | G(G21 − G11_{Mean}) | 4.944647972 | | |
| | G(G12 − G11_{Mean}) | 1.444647972 | | |
| | R(R00 − R11_{Mean}) | 8.333120743 | 6.375 | |
| | R(R20 − R11_{Mean}) | 8.666879257 | | |
| | R(R02 − R11_{Mean}) | 5.166879257 | | |
| | R(R22 − R11_{Mean}) | 3.333120743 | | |
| | B(B11 − B11_{Mean}) | 0 | 0 | |
| 21^{st} | G(G10 − G21_{Mean}) | 40.23742416 | 65.24748483 | 29.65728 |
| block | G(G30 − G21_{Mean}) | 101.7625758 | | |
| | G(G21 − G21_{Mean}) | 42.23742416 | | |
| | G(G12 − G21_{Mean}) | 30.23742416 | | |
| | G(G32 − G21_{Mean}) | 111.7625758 | | |
| | R(R20 − R21_{Mean}) | 1.757359313 | 1.757359313 | |
| | R(R22 − R21_{Mean}) | 1.757359313 | | |
| | B(B11 − B21_{Mean}) | 21.96699141 | 21.96699141 | |
| | B(B31 − B21_{Mean}) | 21.96699141 | | |
| 12^{th} | G(G01 − G12_{Mean}) | 6.85039685 | 4.62992063 | 2.519618 |
| block | G(G21 − G12_{Mean}) | 8.85039685 | | |
| | G(G12 − G12_{Mean}) | 3.14960315 | | |
| | G(G03 − G12_{Mean}) | 3.14960315 | | |
| | G(G23 − G12_{Mean}) | 1.14960315 | | |
| | R(R02 − R12_{Mean}) | 1.464466094 | 1.464466094 | |
| | R(R22 − R12_{Mean}) | 1.464466094 | | |
| | B(B11 − B12_{Mean}) | 1.464466094 | 1.464466094 | |
| | B(B13 − B12_{Mean}) | 1.464466094 | | |
| 22^{nd} | G(G21 − G22_{Mean}) | 45.29700953 | 37.04700953 | 27.56976 |
| block | G(G12 − G22_{Mean}) | 33.29700953 | | |
| | G(G32 − G22_{Mean}) | 34.29700953 | | |
| | G(G23 − G22_{Mean}) | 35.29700953 | | |
| | R(R22 − R22_{Mean}) | 0 | 0 | |
| | B(B11 − B22_{Mean}) | 118.3508586 | 45.66228534 | |
| | B(B31 − B22_{Mean}) | 31.64914136 | | |
| | B(B13 − B22_{Mean}) | 32.64914136 | | |

The interpolation distance is expressed as an absolute value that represents the difference in colors between the interpolated pixel and the adjacent pixel and can be obtained through equation 6.

$$\begin{matrix}Equation 6 & \\ \begin{matrix}\begin{matrix}Interpolation \\ distance\end{matrix} = \sqrt{{( \begin{matrix}mean value of color - \\ color value of adjacent pixel\end{matrix} )}^{2}} \\ = \vert mean value of color - \\ color value of adjacent pixel \vert\end{matrix} & ( 6 )\end{matrix}$$

That is, referring to Table 4 that shows the conventional interpolation distance, the absolute value of difference between the G10 and G11 is 5.75 because the G11 has a color value of 234.25 and the G10 has a color value of 240. In addition, the absolute value of difference between the G01 and G11 is 9.25, the absolute value of difference between the G21 and G11 is 7.75, and the absolute value of difference between the G12 and G11 is 4.25.

The color differential value of G, which is the mean absolute value of G, is 6.75 (=(5.75+9.25+7.75+4.25)/4). In addition, the color differential value of R is 6.75 and the color differential value of B is 0. In addition, the total differential value of the 11^{th} block, which is the mean color differential value of the R/G/B colors, is 4.5(=(6.75+6.75+0)/3).

In the same manner, the total differential value of the corrected 11^{th} block, which is corrected by taking the standard deviation into consideration, is 3.439883.

The total differential value of the corrected 11^{th} block (3.439883) obtained according to an embodiment is smaller than the total differential value of the 11^{th} block (4.5). Thus, it can be understood from the above result that the color difference between the pixel subject to the interpolation and the adjacent pixel can be reduced when the interpolation is performed with respect to the corrected block that is created by taking the standard deviation into consideration.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An image interpolation method comprising:
detecting a color value of each pixel provided in a pixel array;
calculating R/G/B color values of a central pixel aligned at a center of a unit block provided in the pixel array;
calculating R/G/B standard deviations based on a difference between the R/G/B color values of the central pixel and color values of other pixels provided in the pixel block;
creating corrected blocks having color values by comparing the R/G/B color values of the central pixel and the color values of other pixels provided in the pixel block, wherein the color values of the corrected blocks are obtained by taking the R/G/B standard deviations into consideration; and
obtaining an interpolated color value of the central pixel by using the color values of pixels included in the corrected block.

2. The method according to claim 1, wherein the unit block has (odd number)×(odd number) pixels.

3. The method according to claim 2, wherein the unit block has 3×3 pixels.

4. The method according to claim 2, wherein the unit block has 5×5 pixels.

5. The method according to claim 1, wherein calculating the R/G/B color values of the central pixel comprises using a color value detected from the central pixel as it is and obtaining color values that are not detected from the central pixel by using a mean color value of other pixels included in the unit block.

6. The method according to claim 1, wherein creating the corrected blocks comprises:
if the R/G/B color values of the central pixel are equal to or less than the color values of other pixels, correcting the color values of other pixels by adding the R/G/B deviations to the R/G/B color values of the central pixel, and
if the R/G/B color values of the central pixel are greater than the color values of other pixels, correcting the color values of other pixels by subtracting the R/G/B deviations from the R/G/B color values of the central pixel.

7. The method according to claim 1, wherein obtaining the interpolated color value of the central pixel comprises calculating mean color values of the pixels included in the corrected block according to colors.

8. The method according to claim 1, further comprising:
calculating R/G/B color values of a new central pixel while changing a position of the unit block,
calculating new R/G/B standard deviations,
creating a new corrected block, and
obtaining an interpolated color value of the new central pixel,
wherein the calculating of the R/G/B color values of a new central pixel while changing a position of the unit block, the calculating of the new R/G/B standard deviations, the creating of the new corrected block, and the obtaining of the interpolated color value of the new central pixel are repeated to perform an interpolation with respect to a whole region of the pixel array.
